(19) United States
(12) Patent Application Publication
(10) Pub. No.: US 2006/0221885 A1
(43) Pub. Date: Oct. 5, 2006

(54) Power de-boosting on the control channel

(76) Inventor: Shirish Nagaraj, Randolph, NJ (US)

Correspondence Address: LUCENT TECHNOLOGIES INC.;DOCKET ADMINISTRATOR, 101 CRAWFORDS CORNER ROAD - ROOM 3J-219, HOLMDEL, NJ, 07733, US

(21) Appl. No.: 11/093,378

(22) Filed: Mar. 30, 2005

(51) Int. Cl. H04Q 7/00; H04Q 7/24; H04J 3/22; H04J 3/16

(52) U.S. Cl. 370/328; 370/465; 370/338

(57) ABSTRACT

A method for transmitting signaling information on reverse link control channels using less than full or de-boosted transmit power for re-transmissions, thereby increasing overall available power for reverse link packet data transmission. De-boosting is achieved through combining signaling information across multiple or all transmissions. The method comprises the steps of transmitting signaling information using full transmit power for an initial transmission of the signaling information, and transmitting the signaling information using less then full transmit power for re-transmissions of the signaling information. The transmit power of the signaling information re-transmission may depend upon a transmission time interval over which the signaling information is re-transmitted, a re-transmission sequence number, a desired error rate which may be achieved when combining the signaling information re-transmission with one or more previous signaling information transmissions, etc.

### FIELD OF THE INVENTION

The present invention relates generally to telecommunications and, in particular, to reverse link high-speed packet data transmission in wireless communications network.

### BACKGROUND

A need for high-speed packet data services over a reverse link has motivated new developments in third generation wireless standards body, such as the well-known UMTS (Universal Mobile Telecommunications System) and CDMA2000 (Code Division Multiple Access 2000). One of the main goals for reverse link high-speed packet data services is to improve data throughput and coverage as well as reduce delay. This goal is achieved by utilizing well-known fast scheduling techniques at the Medium Access Control (MAC) layer and well-known Hybrid Automatic Repeat reQuest (HARQ) techniques at the physical and MAC layer. Both techniques allow for better control of interference and delay in wireless communications systems, thus making it possible to transmit packet data at high rates.

One reverse link high-speed packet data service is described in the standards specification for UMTS. In UMTS, a packet data service referred to as EUDCH (Enhanced Uplink Dedicated CHannel) or HSUPA (High Speed Uplink Packet Access) is used to provide high-speed packet data services over the reverse link. EUDCH utilizes a reverse link data channel and a reverse link control channel, referred to herein as E-DPDCH (Enhanced Dedicated Physical Data CHannel) and E-DPCCH (Enhanced Dedicated Physical Control Channel), to transmit packet data and associated signaling information from User Equipment (UE) to Node B, respectively.

In EUDCH, the fast scheduling technique is utilized at the MAC layer of Node B to determine a maximum data rate for which a mobile station may transmit packet data over the E-DPDCH. The maximum data rate is communicated to the UE. The UE, however, does not necessarily have to use the maximum data rate for the transmission of packet data. The UE may choose a data rate lower than the maximum data rate due to power and/or information constraints. Because the UE may use a data rate different from the maximum data rate, the UE needs to inform Node B of the data rate it is actually using in order for Node B to be capable of properly decoding the packet data being transmitted over the E-DPDCH. The actual data rate being used by the UE (to transmit packet data) is communicated to Node B over the E-DPCCH. The data rate is included as part of signaling information which also includes, among other things, a re-transmission sequence number (identifying a particular re-transmission within an HARQ process) associated with the packet data being transmitted over the E-DPDCH.

EUDCH implements two possible transmission modes referred to herein as a 2 ms and 10 ms transmission mode, respectively. The 2 ms transmission mode utilizes a 2 ms TTI (transmission time interval) for packet data and signaling information transmission over the E-DPDCH and E-DPCCH, respectively. The 10 ms transmission mode utilizes a 10 ms TTI (transmission time interval) for packet data and signaling information transmission over the E-DPDCH and E-DPCCH, respectively. Unlike the 2 ms transmission mode, in the 10 ms transmission mode, the packet data is sent over a 10 ms TTI and the signaling information is sent five times over a 10 ms TTI. By sending the same signaling information five times over the 10 ms TTI, repletion gain is produced which increases the probability that the signaling information can be successfully decoded at Node B. By contrast, there is no repletion gain for the 2 ms transmission mode. Since there is no repletion gain, it becomes necessary to transmit the signaling information at an higher transmit power (compared to the 10 ms transmission mode) in order to increase the probability that the signaling information can be successfully decoded at Node B.

Using more power for the transmission of signaling information over the E-DPCCH reduces the amount of power available for transmitting packet data over the E-DPDCH. Transmit power is directly related to data rate. Less available power for transmitting packet data results in lower data rates, and vice-versa. Accordingly, there exists a need to increase the amount of power available for packet data transmission over the data channel.

### SUMMARY OF THE INVENTION

The present invention is a method for transmitting signaling information on reverse link control channels using less than full or de-boosted transmit power for re-transmissions, thereby increasing overall available power for reverse link packet data transmission. De-boosting is achieved through combining signaling information across multiple or all transmissions.

The present invention method comprises the steps of transmitting signaling information using full transmit power for an initial transmission of the signaling information, and transmitting the signaling information using less then full transmit power for re-transmissions of the signaling information. The transmit power of the signaling information re-transmission may depend upon a transmission time interval over which the signaling information is re-transmitted, a re-transmission sequence number, a desired error rate which may be achieved when combining the signaling information re-transmission with one or more previous signaling information transmissions, etc. In one embodiment of the present invention, the signaling information is transmitted over a reverse link control channel. In other embodiments, the signaling information is transmitted over a forward link control channel, or packet data is transmitted instead of or in conjunction with the signaling information.

### BRIEF DESCRIPTION OF THE DRAWINGS

The features, aspects, and advantages of the present invention will become better understood with regard to the following description, appended claims, and accompanying drawings where:

FIG. 1 depicts a wireless communications system used in accordance with the present invention; and

FIG. 2 depicts a flowchart for implementing reverse link high speed packet data services in accordance with one embodiment of the present invention.

### DETAILED DESCRIPTION

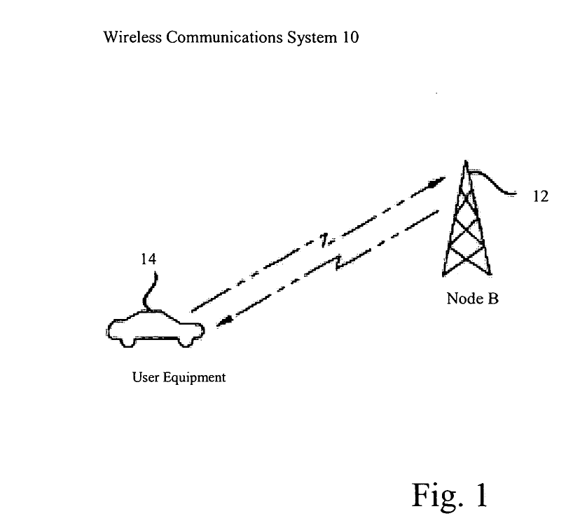

FIG. 1 depicts a wireless communications system 10 used in accordance with the present invention. The wireless communications system 10 will be described herein with reference to the well-known Universal Mobile Telecommunications System (UMTS). It should be understood that the present invention is not limited to use in an UMTS based wireless communications system and that the present invention may also be applicable to wireless communications based on other multiple access technologies, such as Code Division Multiple Access 2000 (CDMA2000).

Wireless communications system 10 comprises a base station 12 and a mobile station 14. In UMTS, the base station and mobile station are referred to as Node B and User Equipment (UE), respectively. A service referred to herein as EUDCH (Enhanced Uplink Dedicated Channel) provides high-speed packet data services on the reverse link utilizing a Hybrid Automatic Repeat reQuest (HARQ) technique at the physical/MAC layer at Node B 12. In EUDCH, a maximum data rate for which UE 14 may use to transmit packet data to Node B 12 is determined by Node B 12 using a fast scheduling algorithm at a Medium Access Control (MAC) layer. Fast scheduling algorithms and MAC layers are well-known in the art.

Node B 12 communicates the maximum data rate to UE 14 over a control channel on the forward link. UE 14 can then choose to transmit packet data to Node B 12 at the maximum data rate or a lower data rate over a data channel referred to herein as E-DPDCH (Enhanced Dedicated Physical Data CHannel). In addition to the packet data transmission, signaling information is transmitted to Node B 12 over a control channel referred to herein as E-DPCCH (Enhanced Dedicated Physical Control CHannel). The signaling information includes the actual data rate at which UE 14 is transmitting packet data over the E-DPDCH and a re-transmission sequence number for indicating a particular packet data re-transmission.

When the signaling information is initially transmitted, i.e., no previous transmission of signaling information, it is transmitted at an initial or full transmit power. The present invention allows for reducing, or de-boosting, the transmit power for re-transmissions of the signaling information, i.e., re-transmit power is less than full transmit power. De-boosting transmit power for re-transmissions of signaling information results in more available transmit power for packet data transmissions which, in turn, allows for higher-speed transmissions. To achieve de-boosting without deceasing decoding reliability of the reverse link control channel over which signaling information is transmitted, the present invention incorporates a combining technique in which multiple transmissions of the signaling information is combined. In one embodiment, the amount of de-boosting depends upon a desired error rate, such as word error rate (WER), bit error rate (BER), frame error rate (FER), etc., that can be achieved by combining one or more previous transmissions of the signaling information with a de-boosted re-transmission.

In another embodiment, the amount of de-boosting, if any, may depend on which transmission mode is being utilized. EUDCH uses a 2 ms and a 10 ms transmission mode for packet data and signaling information transmission over the E-DPDCH and E-DPCCH, respectively. In the 2 ms transmission mode, the packet data and signaling information are sent over 2 ms TTIs. In the 10 ms transmission mode, the packet data is sent over a 10 ms TTI and the same signaling information is sent five times over a 10 ms TTI.

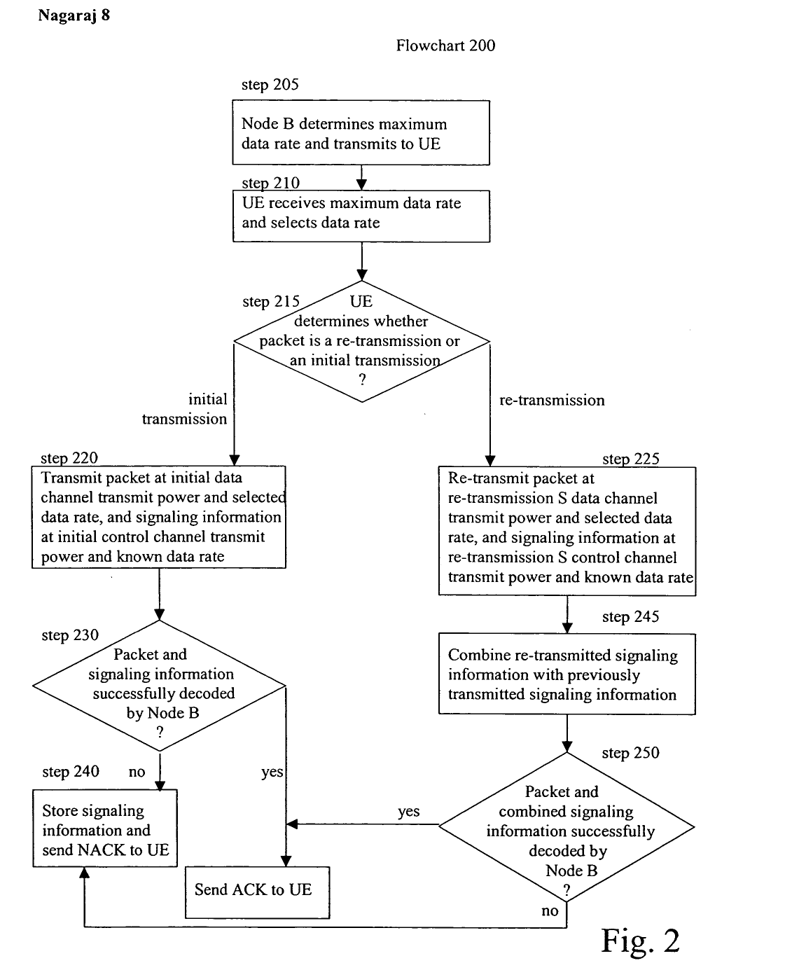

FIG. 2 depicts a flowchart 200 for implementing EUDCH in accordance with one embodiment of the present invention. In step 205, Node B 12 determines a maximum data rate for reverse link transmission of packet data and communicates the maximum data rate to UE 14 in a rate message. In step 210, UE 14 receives the rate message indicating the maximum data rate and selects a data rate equal to or less than the maximum data rate. Before transmitting the packet data, in step 215, UE 14 determines whether the packet data it is about to transmit is an initial transmission or a re-transmission. If it is an initial transmission, then flowchart 200 continues to step 220 where UE 14 transmits the packet data and signaling information over the E-DPDCH and E-DPCCH at an initial or full data and control channel transmit power, respectively. The packet data being transmitted at the data rate selected in step 210, and the signaling information being transmitted at a data rate known to Node B 12, such as a default or predetermined data rate. Otherwise flowchart 200 continues to step 225 from step 215.

From step 220, flowchart 200 continues to step 230 where a determination is made as to whether Node B 12 was able to successfully decode the packet data and signaling information transmitted over the E-DPDCH and E-DPCCH, respectively. If Node B 12 was able to successfully decode the packet data and signaling information from the E-DPDCH and E-DPCCH, then Node B 12 sends an ACK (acknowledgement) to UE 14 indicating successful receipt of the packet data, in step 235. The packet that is successfully received is then processed by Node B 12 in its usual manner.

If, in step 230, Node B 12 was unable to successfully decode the packet data and/or signaling information, then flowchart 200 proceeds to step 240. In step 240, Node B 12 stores the signaling information (whether successfully or unsuccessfully decoded from the E-DPCCH) in memory and sends an NACK (negative acknowledgement) to UE 14 indicating unsuccessful receipt of the data packet. Flowchart 200 subsequently goes to step 215 for initiating the packet data re-transmission.

Returning to step 225 after it has been determined in step 215 that the current packet data transmission is a re-transmission (e.g., an NACK has been received for the previous transmission), UE 14 re-transmits the packet data (which was unsuccessfully decoded at Node B 12) over the E-DPDCH at a re-transmission S data channel transmit power and data rate determined in step 210, wherein S corresponds to the re-transmission sequence number and the re-transmission S data channel transmit power may or may not the same as the initial data channel transmit power. In one embodiment, the re-transmitted packet data is identical to the previous or initial transmission. In another embodiment, the re-transmitted packet data is a different version of the previous or initial transmission which can be combined with the previous or initial transmission.

Also, in step 225, ULE 14 re-transmits the signaling information over the E-DPCCH at a re-transmission S control channel transmit power and data rate known to Node B 12. In one embodiment, the re-transmitted signaling information is identical to the previous or initial transmission (at least with respect to the data rate being indicated in the signaling information). In another embodiment, the re-transmitted signaling information is a different version of the previous or initial transmission.

The re-transmission S control channel transmit power may be lower than the initial control channel transmit power depending upon the transmission mode being utilized. For example, if the transmission mode is 2 ms TTI, the re-transmission S control channel transmit power would be lower than the initial control channel transmit power. But if the transmission mode is 10 ms TTI, the re-transmission S control channel transmit power may be the same or lower than the initial control channel transmit power. In another embodiment, the re-transmission S control channel transmit power would be lower than the initial control channel transmit power used in the initial transmission of the signaling information regardless of the transmission mode.

How the re-transmission S control channel transmit power is determined may be achieved in a variety of manners. One such manner for determining re-transmission S control channel transmit power involves Node B 12 utilizing a table or list associating re-transmission S control channel transmit power with re-transmission sequence number. This table or list may be determined by Node B 12 or by UE 14 (and sent to UE 14 during initial configuration of the high-speed packet data services) based on a one or more criteria, such as a desired error rate, available transmit power, transmission mode, etc. For example, the re-transmission S control channel transmit power is determined such that a certain WER can be achieved if re-transmission S was combined with one or more previous transmissions. Another manner determining re-transmission S control channel transmit power may depend upon, among other things, the re-transmission sequence number and a reduction percentage or increment. For example, if the re-transmission sequence number is 2, then the re-transmission 2 control channel transmit power might be reduced by 20% or two increments from the previous transmission (i.e., re-transmission 1) or initial transmission.

In step 245, Node B 12 receives the packet data and signaling information re-transmitted over the E-DPDCH and E-DPCCH and combines the re-transmitted signaling information with the signaling information stored in step 240. In one embodiment, Node B 12 may also combine re-transmitted packet data with one or more previously transmitted packet data. The manner in which multiple transmissions of the same information can be combined is well-known in the art. One such combining technique involves storing up to four TTIs of information and performing an exhaustive search over all possible hypothesis of re-transmission sequence numbers. See U.S. application Ser. No. 10/835810, entitled “Method And Apparatus For Detecting An Uplink Packet Data Channel In A CDMA Wireless Communications System” by Francis Dominique, et al., filed Apr. 30, 2004, and U.S. application Ser. No. 10/844803, entitled “Reception Method For Packetized Information With Automatic Repeat Request” by Francis Dominique, et al., filed May 13, 2004.

In step 250, Node B 12 attempts to decode the combined signaling information and packet data. If successful, then flowchart 200 proceeds to step 235 where Node B sends an ACK to UE 14 indicating successful receipt of the packet data. The successfully received packet data is then processed by Node B 12 in its usual manner. If decoding is unsuccessful in step 250, then flowchart 200 proceeds to step 240 where Node B 12 stores the combined signaling information (whether successfully or unsuccessfully decoded) in memory and sends an NACK to UE 14 indicating unsuccessful receipt of the data packet. Flowchart 200 subsequently goes to step 215 for re-transmitting the packet data.

By combining signaling information across re-transmissions at Node B 12, re-transmissions of signaling information can be at a lower power than previous transmissions of signaling information in order to achieve a WER for re-transmissions similar to the WER for initial transmissions at full transmit power. By lowering the transmit power for re-transmissions of signaling information, more overall transmit power becomes available for high-speed packet data transmissions on the reverse link which results in higher speed and more reliable reverse link packet data transmissions.

Although the present invention has been described in considerable detail with reference to certain embodiments, other versions are possible. For example, the present invention may be used for high-speed packet data transmissions on the forward or reverse link, or it may be used in conjunction with some protocol other than HARQ, or the steps in flowchart 200 may be performed in a different sequence, etc. Therefore, the spirit and scope of the present invention should not be limited to the description of the embodiments contained herein.

1. A method for transmitting signaling information over a reverse link control channel in a wireless communication system comprising the steps of:
transmitting signaling information at a first transmit power if the signaling information transmission is an initial transmission; and
transmitting the signaling information at a second transmit power if the signaling information transmission is a re-transmission, wherein the second transmit power is lower than the first transmit power.

2. The method of claim 1 comprising the additional steps of:
receiving a maximum data rate at which the signaling information may be transmitted; and
transmitting packet data at a data rate equal to or less than the maximum data rate, wherein signaling information includes an indication of the data rate at which the packet data is being transmitted.

3. The method of claim 1 comprising the additional step of:
receiving a message indicating the second transmit power.

4. The method of claim 1 comprising the additional step of:
determining the second transmit power using the message.

5. The method of claim 1 comprising the additional step of:
determining the second transmit power based on an error rate associated with combining the re-transmission of the signaling information with one or more previous transmissions of the signaling information.

6. The method of claim 1 comprising the additional step of:
determining the second transmit power based on a transmission mode associated with the re-transmission of the signaling information.

7. The method of claim 1 comprising the additional step of:
determining the second transmit power based on overall transmit power available.

8. The method of claim 1 comprising the additional step of:
receiving the initial transmission of the signaling information;
receiving the re-transmission of the signaling information; and
combining the initial and re-transmission of the signaling information.

9. The method of claim 8 comprising the additional steps of:
determining the second transmit power; and
transmitting a message indicating the second transmit power.

10. A method for receiving signaling information over a reverse link control channel in a wireless communication system comprising the steps of:
transmitting a message over a forward link indicating a first transmit power;
receiving an initial transmission of signaling information over a reverse link control channel transmitted at a second transmit power, the first transmit power being lower than the second transmit power; and
receiving a re-transmission of the signaling information over the reverse link control channel transmitted at the first transmit power.

11. The method of claim 10 comprising the additional steps of:
combining the initial transmission and the re-transmission to obtain the signaling information.

12. The method of claim 10, wherein the message includes a maximum data rate at which packet data may be transmitted.

13. The method of claim 10, wherein the signaling information of the re-transmission includes a first data rate indication identical to a second data rate indication which was included in the signaling information of the initial transmission.

14. A method for transmitting information over a radio link in a wireless communication system comprising the steps of:
transmitting information at a first transmit power if the information transmission is an initial transmission; and
transmitting the information at a second transmit power if the information being transmitted is a re-transmission over a first transmission time interval, wherein the second transmit power is less than or equal to the first transmit power;
transmitting the information at a third transmit power if the information being transmitted is a re-transmission over a second transmission time interval, wherein the third transmit power is less than the first transmit power and the second transmission time interval is greater in duration than the first transmission time interval.

15. The method of claim 14, wherein the radio link can either be a forward link or reverse link.

16. The method of claim 14, wherein the radio link is a reverse link control channel.

17. The method of claim 14, wherein the first transmission mode utilizes a 2 millisecond transmission time interval and the second transmission mode utilizes a 10 millisecond transmission time interval.

18. The method of claim 14, wherein the second transmit power is based on one or more of the following criteria: an error rate associated with combining the re-transmission of the signaling information with one or more previous transmissions of the signaling information; a transmission mode associated with the re-transmission of the signaling information; or overall transmit power available.

19. The method of claim 14, wherein the information is packet data.

20. The method of claim 1 comprising the additional step of:
receiving a message indicating the second transmit power.
